(19) United States
(12) Patent Application Publication
(10) Pub. No.: US 2021/0264896 A1
(43) Pub. Date: Aug. 26, 2021

(54) INFORMATION PROCESSING DEVICE, INFORMATION PROCESSING METHOD, AND INFORMATION PROCESSING SYSTEM

(71) Applicant: SHARP KABUSHIKI KAISHA, Sakai City (JP)

(72) Inventor: AKIHIRO KAGAMI, Sakai City (JP)

(21) Appl. No.: 17/181,301

(22) Filed: Feb. 22, 2021

(30) Foreign Application Priority Data
Feb. 25, 2020 (JP) 2020-029187

(51) Int. Cl. G10L 13/027; G10L 13/04; G10L 25/63; G10L 15/07; G06K 9/00

(52) U.S. Cl. CPC G10L 13/027; G10L 13/04; G06K 9/00369; G10L 15/07; G10L 25/63

(57) ABSTRACT

An information processing device includes a reception unit configured to receive an attribute of one or more persons from another device separate from the information processing device; a determination unit configured to determine whether to continue a scenario for executing interaction or select another scenario, based on the attribute received by the reception unit; a voice synthesizing unit configured to generate voice data for at least one person of the one or more persons, based on the determination by the determination unit; and a transmission unit configured to transmit the voice data generated by the voice synthesizing unit to the other device.

### CROSS-REFERENCE TO RELATED APPLICATION

The present application claims priority from Japanese Application JP2020-029187, the content to which is hereby incorporated by reference into this application.

### BACKGROUND OF THE INVENTION

### 1. Field of the Invention

Aspects of the present disclosure relate to an information processing device, an information processing method, and an information processing system.

### 2. Description of the Related Art

In JP 2018-97185 A, for example, there is disclosed a voice-interactive device capable of interacting with a person by voice. This device determines attributes of a person from image data captured by a camera, voice collected by a microphone, and the like, selects a scenario based on the attributes to interact with the person.

### SUMMARY OF THE INVENTION

In a case where such a voice-interactive device is installed in a public space, the person interacting with the device may change midway through an interaction. The voice-interactive device described above determines a target person only once and thus, depending on the timing of determination of the target person, may select a scenario for the person before the change or may select a scenario for the person after the change. Therefore, in a voice-interactive device such as described above, an inappropriate interaction based on an inappropriate scenario may occur.

Thus, an aspect according to the present disclosure has been made in view of the problems described above, and an object of the present disclosure is to provide an information processing device, an information processing method, and an information processing system capable of selecting a more suitable scenario and performing more appropriate interaction even in a case where a person taking part in an interaction changes midway through the interaction.

An information processing device according to an aspect of the present disclosure includes a reception unit, a determination unit, a voice synthesizing unit, and a transmission unit. The reception unit is configured to receive an attribute of one or more persons from another device separate from the information processing device. The determination unit is configured to determine whether to continue a scenario for executing interaction or select another scenario, based on the attribute received by the reception unit. The voice synthesizing unit is configured to generate voice data for at least one person of the one or more persons, based on the determination by the determination unit. The transmission unit is configured to transmit the voice data generated by the voice synthesizing unit to the other device.

An information processing device according to another aspect of the present disclosure is configured to receive an image including one or more persons from another device separate from the information processing device. The information processing device is configured to determine an attribute of the one or more persons, based on the image thus received. The information processing device is configured to determine whether to continue a scenario for executing interaction or select another scenario, based on the attribute thus determined. The information processing device is configured to generate voice data for at least one person of the one or more persons, based on the determination. The information processing device is configured to transmit the voice data thus generated to the other device.

An information processing method according to yet another aspect of the present disclosure is executed by an information processing device. The information processing method includes receiving an attribute of one or more persons from another device separate from the information processing device, determining whether to continue a scenario for executing interaction or select another scenario, based on the attribute thus received, generating voice data for at least one person of the one or more persons, based on the determination, and transmitting the voice data thus generated to the other device.

An information processing system according to yet another aspect of the present disclosure includes a first information processing device and a second information processing device. The first information processing device is configured to determine, based on an image including one or more persons, an attribute of the one or more persons. The first information processing device is configured to transmit the attribute thus determined to the second information processing device. The second information processing device is configured to receive the attribute from the first information processing device. The second information processing device is configured to determine whether to continue a scenario for executing interaction or select another scenario, based on the attribute thus received. The second information processing device is configured to generate voice data for at least one person of the one or more persons, based on the determination. The second information processing device is configured to transmit the voice data thus generated to the first information processing device. The first information processing device is configured to receive the voice data from the second information processing device. The first information processing device is configured to output the voice data for the at least one person of the one or more persons.

An information processing device according to yet another aspect of the present disclosure is configured to determine, based on an image including one or more persons, an attribute of the one or more persons. The information processing device is configured to determine whether to continue a scenario for executing interaction or select another scenario, based on the attribute thus determined. The information processing device is configured to generate voice data for at least one person of the one or more persons, based on the determination. The information processing device is configured to output the voice data for the at least one person of the one or more persons.

An information processing device according to yet another aspect of the present disclosure includes a processing device, a storage device, and a communication device. The storage device is configured to store a program. The processing device is configured to execute the program stored in the storage device and, when executing the program, receive an attribute of one or more persons from another device separate from the information processing device via the communication device, determine whether to continue a scenario for executing interaction or select another scenario, based on the attribute thus received via the communication device, generate voice data for at least one person of the one or more persons, based on the determination, and transmit the voice data thus generated to the other device via the communication device.

An information processing device according to yet another aspect of the present disclosure includes a processing device and a storage device. The storage device is configured to store a program. The processing device is configured to execute the program stored in the storage device and, when executing the program, determine, based on an image including one or more persons, an attribute of the one or more persons, determine whether to continue a scenario for executing interaction or select another scenario, based on the attribute thus determined, generate voice data for at least one person of the one or more persons, based on the determination, and output the voice data for the at least one person of the one or more persons.

According to aspects of the present disclosure, it is possible to select a more suitable scenario and perform more appropriate interaction even in a case where a person taking part in an interaction changes midway through the interaction.

### BRIEF DESCRIPTION OF THE DRAWINGS

FIG. 1 is a drawing illustrating an example of an overall configuration of an information processing system configured to provide voice interaction, according to an embodiment.

FIG. 2 is a block diagram illustrating an example of a hardware configuration of a digital signage according to the embodiment.

FIG. 3 is a block diagram illustrating an example of a functional configuration of the digital signage according to the embodiment.

FIG. 4 is a block diagram illustrating an example of a hardware configuration of a server according to the embodiment.

FIG. 5 is a block diagram illustrating an example of a functional configuration of the server according to the embodiment.

FIG. 6 is a drawing illustrating an example of scenario selection according to the embodiment.

FIG. 7 is a drawing illustrating an example of scenario selection according to the embodiment.

FIG. 8 is a drawing illustrating an example of scenario selection according to the embodiment.

FIG. 9 is a drawing illustrating an example of scenario selection according to the embodiment.

FIG. 10 is a drawing illustrating an example of scenario selection according to the embodiment.

FIG. 11 is a drawing illustrating an example of scenario selection according to the embodiment.

FIG. 12 is a flowchart illustrating an example of an information processing method for providing voice interaction, according to the embodiment.

FIG. 13 is a flowchart illustrating an example of the information processing method for providing voice interaction, according to the embodiment.

FIG. 14 is a flowchart illustrating an example of the information processing method for providing voice interaction, according to the embodiment.

### DETAILED DESCRIPTION OF THE INVENTION

An embodiment of the present disclosure will be described below with reference to the drawings. The embodiment below is merely exemplary and embodiments to which the present disclosure can be applied are not limited to the embodiment described below.

### Configuration of System

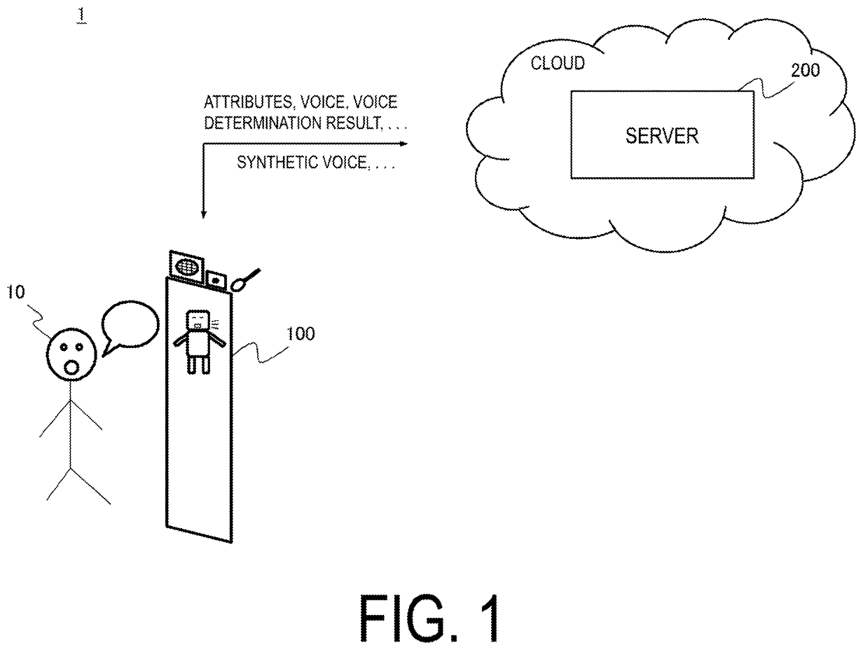

FIG. 1 is a drawing illustrating an example of an overall configuration of an information processing system 1 configured to provide voice interaction, according to an embodiment. As illustrated in FIG. 1, the system 1 includes a digital signage 100 and a server 200 on a cloud. The digital signage 100 is an example of an information processing device or a first information processing device to which the present disclosure can be applied, and is installed, for example, at a store such as a shop or a department store, or at an entrance or exit of a facility such as a park, a station, or a school. The digital signage 100 can display, for a person 10 in front of the digital signage 100, an advertisement of a product sold at the shop or the department store, or the like, and provide a voice guide for providing guidance inside the facility in an interactive manner (that is, in response to an inquiry from the person 10). The information processing device to which the present disclosure can be applied need not include a display function, and may have only the functions described below without the display function. The server 200 is also an example of an information processing device or a second information processing device to which the present disclosure can be applied. The server 200 is on a cloud, and thus may also be referred to as a cloud device. The digital signage 100 and the server 200 communicate with each other via a network (not illustrated) including, for example, a mobile communication network, a Local Area Network (LAN), a Wide Area Network (WAN), the Internet, or a combination thereof. Information communicated between the digital signage 100 and the server 200 includes, for example, attributes of the person 10 located in front of the digital signage 100 based on an image of the person 10, a voice spoken by the person 10 located in front of the digital signage 100 and a determination result thereof, and a synthetic voice output to the person 10 located in front of the digital signage 100.

### Configuration of Digital Signage 100

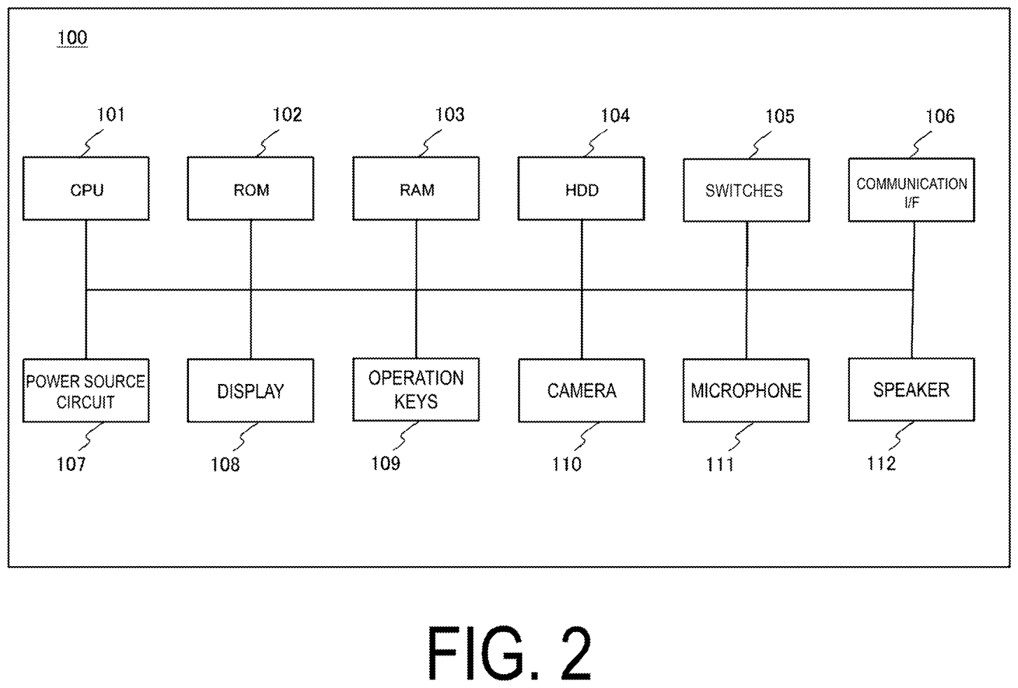

FIG. 2 is a block diagram illustrating an example of a hardware configuration of the digital signage 100 according to the embodiment. As illustrated in FIG. 2, the digital signage 100 includes a Central Processing Unit (CPU) 101, a Read Only Memory (ROM) 102, a Random Access Memory (RAM) 103, a Hard Disk Drive (HDD) 104, switches 105, a communication interface (I/F) 106, a power source circuit 107, a display 108, operation keys 109, a camera 110, a microphone 111, and a speaker 112. These components are connected to each other via a bus.

The CPU 101 executes programs stored in a storage device or a storage medium, such as the ROM 102, the RAM 103, or the HDD 104, and controls the overall operation of the digital signage 100.

The ROM 102 stores programs and data in a non-volatile manner.

The RAM 103 stores programs, data generated when the CPU 101 executes programs, and data input via an input device (operation keys 109 or the like) in a volatile manner.

The HDD 104 stores an operating system, various application programs, various types of data, and the like.

The switches 105 include a main power source switch configured to switch whether power is to be supplied to the power source circuit 107, and various other push-button switches.

The communication I/F 106 is an interface device configured to transmit data to other devices (e.g., the server 200) over a network and receive data from other devices over a network.

The power source circuit 107 is a circuit configured to step down a voltage of a commercial power source and supply power to each component of the digital signage 100.

The display 108 includes a liquid crystal display, and may be configured as a touch screen for displaying various types of data and receiving input. The display 108 displays guidance and the like for a person located in front of the digital signage 100, linking the guidance with a synthetic voice output via the speaker 112 under the control of the CPU 101.

The operation keys 109 include a key (button) for turning the main power source of the digital signage 100 on and off, and a key (button) for selecting an item displayed on the display 108.

The camera 110 is an imaging apparatus configured to take an image of a subject such as a person located in front of the digital signage 100. In the present embodiment, an image taken by the camera 110 (image data after digital conversion) is sent to the CPU 101, and the CPU 101 executes predetermined processing on the image data.

The microphone 111 is a device configured to collect a voice spoken by a person located in front of the digital signage 100, and the like. In the present embodiment, sound collected by the microphone 111 (audio data after digital conversion) is sent to the CPU 101, and the CPU 101 executes predetermined processing on the audio data.

The speaker 112, for example, outputs a synthetic voice for the person located in front of the digital signage 100. The synthetic voice is generated and transmitted by the server 200 and received via the communication I/F 106.

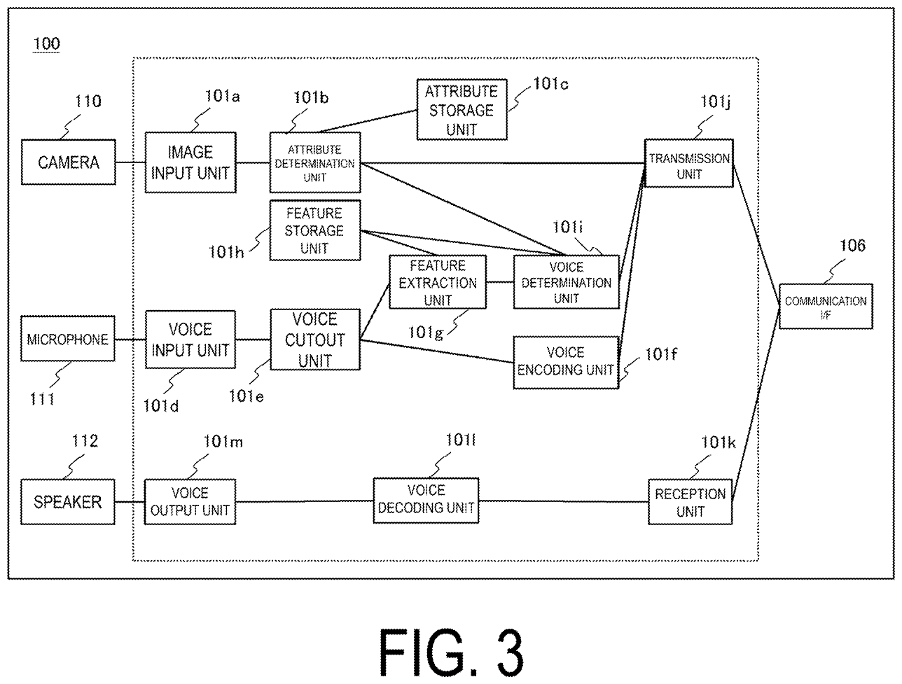

In the present embodiment, the processing performed by the digital signage 100 may be achieved by software (a program) executed by each hardware and the CPU 101. Such a program may be stored in advance in the HDD 104, or may be stored in another storage medium and distributed as a program product. Alternatively, such a program may be provided as a program product downloadable via the Internet. When such a program is loaded into the RAM 103 from the HDD 104 or the like and executed by the CPU 101, the CPU 101 serves as a functional unit illustrated in FIG. 3 described later, for example.

FIG. 3 is a block diagram illustrating an example of a functional configuration of the digital signage 100 according to the embodiment. The digital signage 100 includes, as functional units illustrated within the dotted rectangle, an image input unit 101a, an attribute determination unit 101b, an attribute storage unit 101c, a voice input unit 101d, a voice cutout unit 101e, a voice encoding unit 101f, a feature extraction unit 101g, a feature storage unit 101h, a voice determination unit 101i, a transmission unit 101j, a reception unit 101k, a voice decoding unit 101l, and a voice output unit 101m.

The image input unit 101a receives, from the camera 110, an image of a person or the like taken by the camera 110, and outputs the received image to the attribute determination unit 101b.

The attribute determination unit 101b analyzes the image output by the image input unit 101a, determines the attributes of one or more persons along with the number of persons in the image, and stores in the attribute storage unit 101c and outputs to the transmission unit 101j the determined attributes, in association with the current time at which the attributes were determined and the analyzed image. The attribute determination unit 101b further determines whether previous attributes stored in the attribute storage unit 101c within a predetermined time from the current time exist, and whether at least one of the current attributes of the one or more persons matches any one of the previous attributes, and notifies the voice determination unit 101i of the determination result. In the present embodiment, the attributes of a person include a gender and an age of the person, but are not limited thereto. Further, the predetermined time is, for example, 30 seconds, but is not limited thereto. Note that the determination of the attributes may be based on one image or may be based on continuous (for example, a predetermined number of) images (that is, a moving image). More specifically with regard to determination of the attributes, the attribute determination unit 101b, by using face image data including information related to gender and age to execute a known learning process, determines, from an image output by the image input unit 101a, the gender and the age of the person in the image. The attribute determination unit 101b may detect a face and lips of the person in the image from continuous images output by the image input unit 101a, and may function as a speaker detection unit for detecting a speaker from movement of the lips. For example, in a case where a plurality of persons are present in an image and the attribute determination unit 101b determines the attributes of the plurality of persons, the attribute determination unit 101b may output the determined attributes along with information indicating the speaker among the plurality of persons to the transmission unit 101j for transmission to the server 200 for processing, such as scenario determination, in the server 200. Of course, even in a case where only one person exists in the image, when the attribute determination unit 101b detects that the person is speaking, the attribute determination unit 101b can output the determined attributes of the one person along with information indicating that the person is the speaker to the transmission unit 101j for transmission to the server 200.

The attribute storage unit 101c stores the determined attributes, the time at which the attributes are determined, and the analyzed image.

The voice input unit 101d receives, from the microphone 111, the audio data collected by the microphone 111, and outputs the received audio data to the voice cutout unit 101e.

The voice cutout unit 101e, while removing noise, cuts out the voice data from the start of speech to an interruption in the speech from the audio data output by the voice input unit 101d, and outputs the voice data thus cut out to the voice encoding unit 101f and the feature extraction unit 101g. Note that the voice cutout unit 101e need not be present, and in such a case, the audio data may be output as is to the voice encoding unit 101f and the feature extraction unit 101g.

The voice encoding unit 101f encodes the voice data output by the voice cutout unit 101e to generate encoded voice data, and outputs the encoded voice data to the transmission unit 101j. Note that the voice cutout unit 101e and the voice encoding unit 101f may be configured as the same functional unit.

The feature extraction unit 101g extracts features from the voice data output by the voice cutout unit 101e, and stores in the feature storage unit 101h and outputs to the voice determination unit 101i the extracted features in association with the current time at which the features were extracted. In the present embodiment, the features include a mel-frequency cepstral coefficient (MFCC), ΔMFCC, and fundamental frequency (F0) information, ΔF0, but are not limited thereto.

The feature storage unit 101h stores the extracted features and the time at which the features were extracted.

In a case where a positive determination result is notified from the attribute determination unit 101b, the voice determination unit 101i makes the following determination. The voice determination unit 101i executes a known speaker verification process in a case where there is a previous feature stored in the feature storage unit 101h within a predetermined time from the current time, thereby comparing the current feature output by the feature extraction unit 101g and the previous feature stored in the feature storage unit 101h and determining whether the speaker (person) of the voice has changed. In the present embodiment, the predetermined time is, for example, 30 seconds, but is not limited thereto. Further, in a case where there is a previous feature stored in the feature storage unit 101h within a predetermined time from the current time, the voice determination unit 101i may determine the attributes of the speaker (here, at least one of gender and age) based on current features output by the feature extraction unit 101g through prior learning, for example. The voice determination unit 101i outputs a determination result indicating whether the speaker has changed and/or the determined attributes of the speaker to the transmission unit 101j.

The transmission unit 101j transmits the current attributes output by the attribute determination unit 101b, the encoded voice data output by the voice encoding unit 101f, the determination result and/or the determined attributes of the speaker output by the voice determination unit 101i in a case where the determination described above is made by the voice determination unit 101i, and, as necessary, information indicating the speaker detected by the attribute determination unit 101b to the server 200 via the communication I/F 106.

The reception unit 101k receives, via the communication I/F 106, the encoded voice data transmitted by the server 200, and outputs the encoded voice data to the voice decoding unit 101l.

The voice decoding unit 101l decodes the encoded voice data output by the reception unit 101k to generate voice data, and outputs the voice data to the voice output unit 101m.

The voice output unit 101m outputs the voice data output by the voice decoding unit 101l to the speaker 112, and the speaker 112 outputs the voice data output by the voice output unit 101m, the voice data being for the person.

The image input unit 101a, the attribute determination unit 101b, the voice input unit 101d, the voice cutout unit 101e, the voice encoding unit 101f, the feature extraction unit 101g, the voice determination unit 101i, the transmission unit 101j, the reception unit 101k, the voice decoding unit 101l, and the voice output unit 101m may be program modules realized by the CPU 101 executing a program. Further, the attribute storage unit 101c and the feature storage unit 101h may be regions provided to the RAM 103 by the CPU 101 executing a program. In another embodiment, these functional units may be configured by a logic circuit (hardware) formed in an integrated circuit (IC chip) or the like, each functional unit may be configured by one or more integrated circuits, or a plurality of functional units may be configured by one integrated circuit.

### Configuration of Server 200

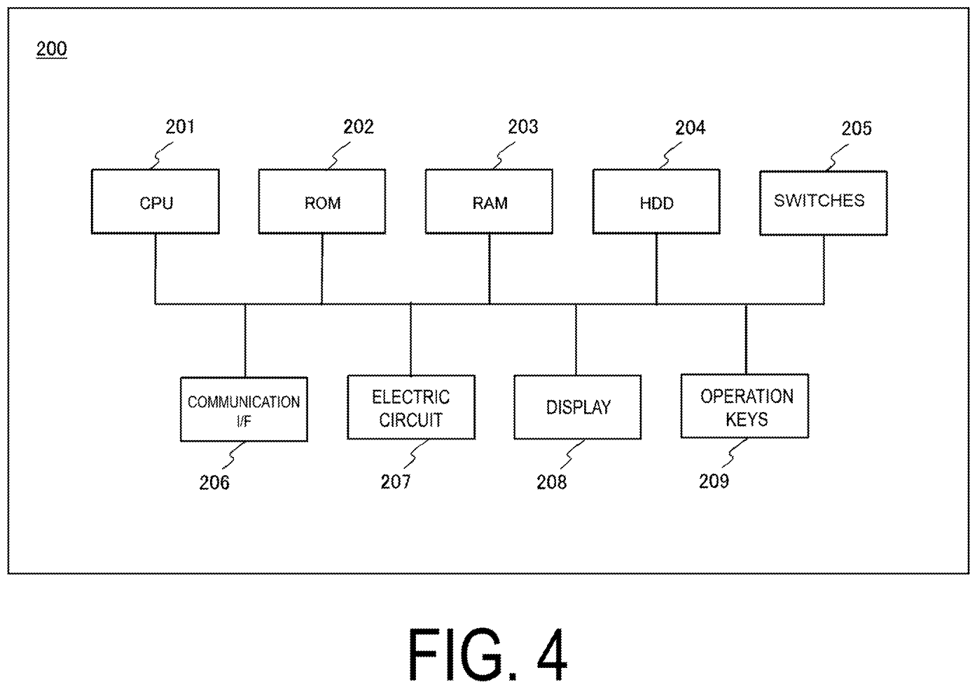

FIG. 4 is a block diagram illustrating an example of a hardware configuration of the server 200 according to the embodiment. As illustrated in FIG. 4, the server 200 includes a CPU 201, a ROM 202, a RAM 203, an HDD 204, switches 205, a communication I/F 206, a power source circuit 207, a display 208, and operation keys 209. These components are connected to each other via a bus.

The CPU 201 executes programs stored in a storage device or a storage medium, such as the ROM 202, the RAM 203, or the HDD 204, and controls the overall operation of the server 200.

The ROM 202 stores programs and data in a non-volatile manner.

The RAM 203 stores programs, data generated when the CPU 201 executes programs, and data input via an input device (operation keys 209 or the like) in a volatile manner.

The HDD 204 stores an operating system, various application programs, various types of data, and the like.

The switches 205 include a main power source switch configured to switch whether power is to be supplied to the power source circuit 207, and various other push-button switches.

The communication I/F 206 is an interface device configured to transmit data to other devices (e.g., digital signage 100) over a network and receive data from other devices over a network.

The power source circuit 207 is a circuit configured to step down the voltage of a commercial power source and supply power to each component of the server.

The display 208 includes a liquid crystal display, and may be configured as a touch screen for displaying various types of data and receiving input. The display 208 may not exist, in which case a remote display may perform functions similar to those of the display 208.

The operation keys 209 include a key (button) for turning the main power source of the server 200 on and off, and a key (button) for selecting an item displayed on the display 208.

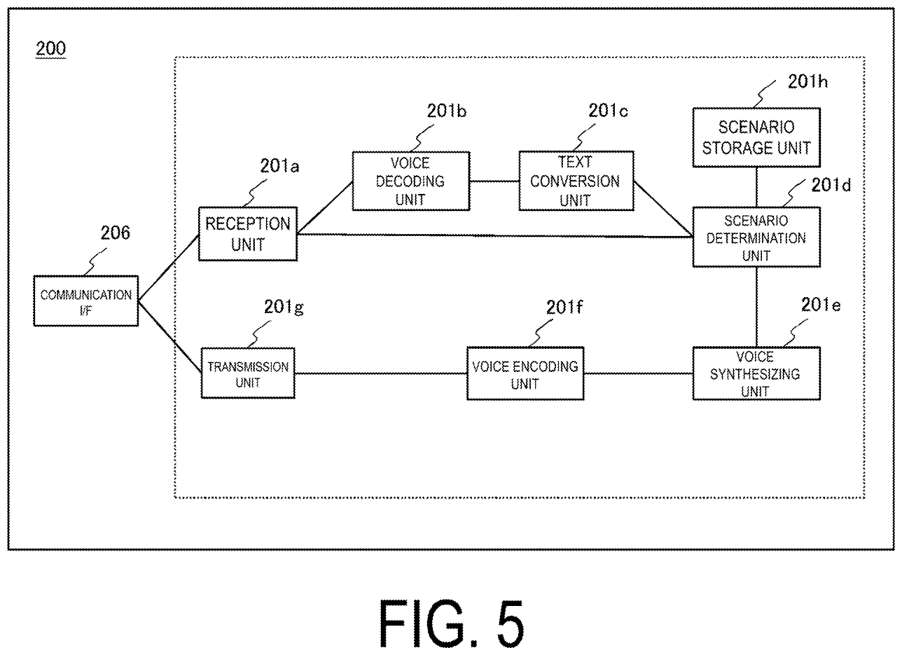

In the present embodiment, the processing of the server 200 may be achieved by software (a program) executed by each hardware and the CPU 201. Such a program may be stored in advance in the HDD 204, or may be stored in another storage medium and distributed as a program product. Alternatively, such a program may be provided as a program product downloadable via the Internet. When such a program is loaded into the RAM 203 from the HDD 204 or the like and executed by the CPU 201, the CPU 201 serves as a functional unit illustrated in FIG. 5 described later, for example.

FIG. 5 is a block diagram illustrating an example of a functional configuration of the server 200 according to the embodiment. The server 200 includes, as functional units illustrated within the dotted rectangle, a reception unit 201a, a voice decoding unit 201b, a text conversion unit 201c, a scenario determination unit 201d, a voice synthesizing unit 201e, a voice encoding unit 201f, a transmission unit 201g, and a scenario storage unit 201h.

The reception unit 201a receives, via the communication I/F 206, the current attributes, the encoded voice data, a determination result and/or determined attributes of the speaker when existent, and, as necessary, information indicating the speaker, which are transmitted by the digital signage 100. Next, the reception unit 201a outputs the encoded voice data to the voice decoding unit 201b, and outputs the current attributes, the determination result and/or the determined attributes of the speaker when existent, and, as necessary, information indicating the speaker to the scenario determination unit 201d.

The voice decoding unit 201b decodes the encoded voice data output by the reception unit 201a to generate voice data, and outputs the voice data to the text conversion unit 201c.

The text conversion unit 201c converts the voice data output by the voice decoding unit 201b into text data to generate text data, and outputs the generated text data to the scenario determination unit 201d.

The scenario determination unit 201d determines whether to continue a scenario for executing interaction with a person or select another scenario (e.g., a new scenario) based on the text data output by the text conversion unit 201c, the current attributes output by the reception unit 201a, the determination result and/or the determined attributes of the speaker output by the reception unit 201a when existent, and, as necessary, information indicating the speaker output by the reception unit 201a. Such scenarios (scenarios such as those shown in Tables 1 to 6 below, for example) are stored in advance in the scenario storage unit 201h in association with the type of interaction with one or more persons for which the scenario is to be used. Next, the scenario determination unit 201d selects the text data of the voice to be output to the person based on such scenarios, and outputs the selected text data to the voice synthesizing unit 201e.

The voice synthesizing unit 201e, by executing known voice synthesizing processing, converts the text data output by the scenario determination unit 201d into voice data to generate voice data, and outputs the generated voice data to the voice encoding unit 201f.

The voice encoding unit 201f encodes the voice data output by the voice synthesizing unit 201e to generate encoded voice data, and outputs the encoded voice data to the transmission unit 201g.

The transmission unit 201g transmits the encoded voice data output by the voice encoding unit 201f to the digital signage 100 via the communication I/F 206.

The reception unit 201a, the voice decoding unit 201b, the text conversion unit 201c, the scenario determination unit 201d, the voice synthesizing unit 201e, the voice encoding unit 201f, and the transmission unit 201g may be program modules realized by the CPU 201 executing a program. Further, the scenario storage unit 201h may be a region provided to the RAM 203 by the CPU 201 executing a program. In another embodiment, these functional units may be configured by a logic circuit (hardware) formed in an integrated circuit (IC chip) or the like, each functional unit may be configured by one or more integrated circuits, or a plurality of functional units may be configured by one integrated circuit.

Note that at least a portion of the functional units included in the digital signage 100 may be included in the server 200, and at least a portion of the functional units included in the server 200 may be included in the digital signage 100. For example, all functional units other than the transmission unit and the reception unit included in the server 200 may be included in the digital signage 100 so that the data to be communicated between the digital signage 100 and the server 200 is not communicated. Further, the voice cutout unit 101e, the feature extraction unit 101g, the feature storage unit 101h, and the voice determination unit 101i included in the digital signage 100 may be included in the server 200. With this configuration, the audio data collected by the microphone 111 may be transmitted to the server 200, and the server 200 receiving the audio data may determine, by using the functional units described above, whether the speaker (person) has changed and/or the attributes of the speaker. According to the configurations in FIG. 4 and FIG. 5 described above, the image itself is not transmitted from the digital signage 100 to the server 200, and thus the effects of a delay caused by such transmission can be mitigated. Nevertheless, the functional units involved in attribute determination and included in the digital signage 100 may be included in the server 200 under condition that the image itself is transmitted to the server 200. With this configuration, while there is an effect of a delay caused by transmission, the server 200 having a higher performance can process the attribute determination including image processing. Further, the order of the functional units described above may be changed as appropriate. For example, the voice encoding unit 101f may exist before the voice cutout unit 101e.

### Operation of Information Processing System 1

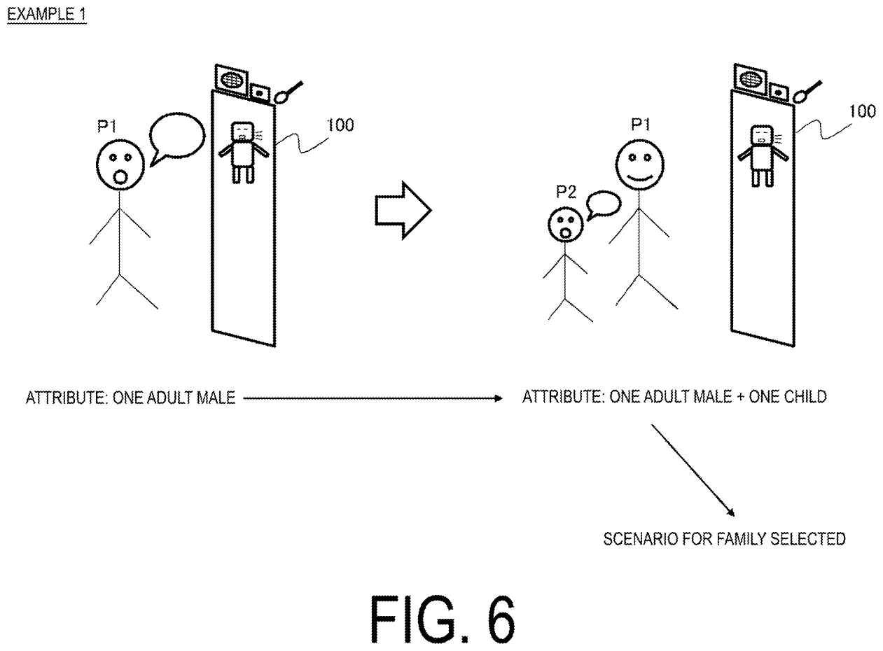

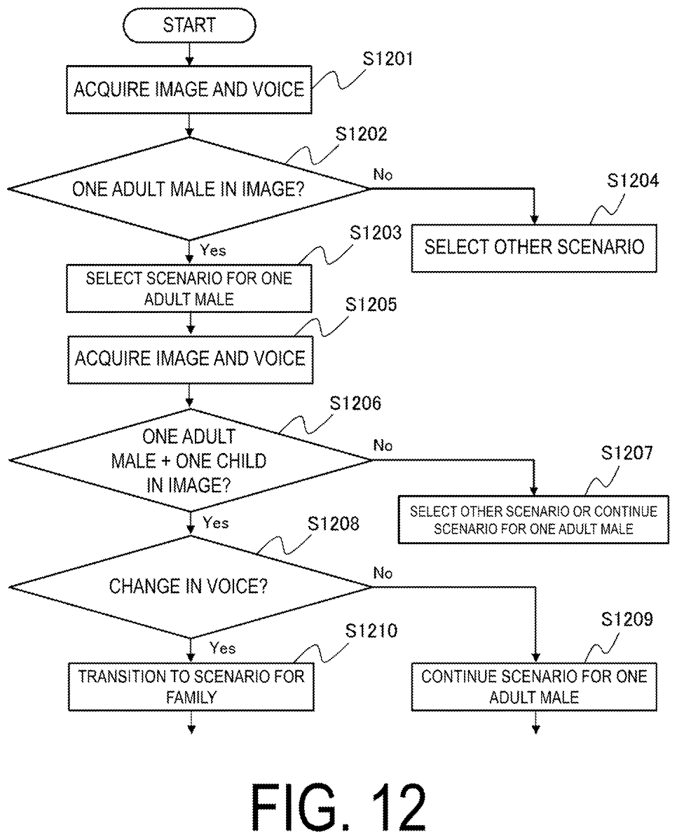

Next, the operation of the information processing system 1 (digital signage 100 and server 200) will be described with reference to FIG. 6 to FIG. 11, which illustrate examples of scenario selection in accordance with the embodiment, and FIG. 12 to FIG. 14, which illustrate examples of an information processing method for providing voice interaction in accordance with the embodiment.

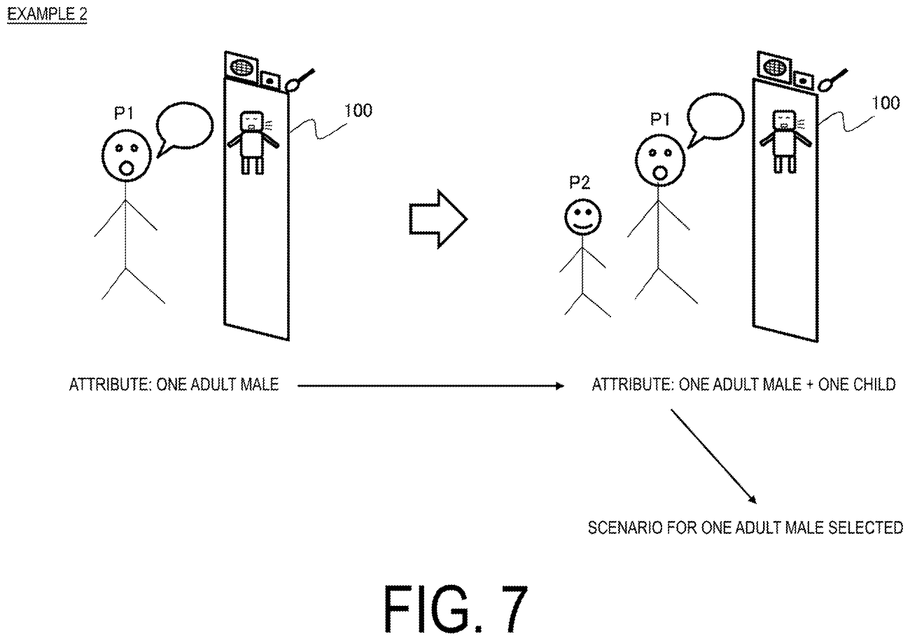

Example 1 illustrated in FIG. 6 assumes a case in which, at first, one adult male speaks to the digital signage 100, and subsequently one child further appears in front of the digital signage 100 and speaks to the digital signage 100. Example 2 illustrated in FIG. 7 assumes a case in which, at first, one adult male speaks to the digital signage 100, subsequently one child further appears in front of the digital signage 100, and the adult male speaks to the digital signage 100 again. FIG. 12 is a flowchart illustrating an example of the information processing method for providing voice interaction in connection with Example 1 and Example 2 according to the embodiment. In the following description, Table 1 and Table 2 respectively showing examples of a scenario for a family and a scenario for one child are referred to as appropriate.

In S1201, the following processing is executed. The camera 110 takes an image of a subject (adult male) appearing in a space in front of the digital signage 100, digitizes the image taken, and outputs the digitized image to the image input unit 101a. In response, the digital signage 100 outputs a voice saying, for example, “Welcome! Are you looking for something?” (refer to Table 1 or Table 2). Furthermore, in response, the adult male speaks, saying, for example, “I came to buy clothes” (refer to Table 1 or Table 2). The microphone 111 collects and digitizes this speech and outputs the digitized speech to the voice input unit 101d. The image input unit 101a outputs the image data to the attribute determination unit 101b, and the voice input unit 101d outputs the audio data to the voice cutout unit 101e.

In S1202, the following processing is executed. The attribute determination unit 101b, as described above, analyzes the image, determines the gender(s) and age(s) of the person(s) along with the number of persons in the image, and stores in the attribute storage unit 101c and outputs to the transmission unit 101j the determined gender(s) and age(s) (that is, there is one adult male) in association with the current time at which the attributes were determined and the image. Here, the condition that previous attributes stored in the attribute storage unit 101c within a predetermined time from the current time exist, and at least one of the current attributes of the one or more persons matches any one of the previous attributes is not satisfied, and thus the attribute determination unit 101b notifies the voice determination unit 101i of the above-described determination result, which is negative. As a result of this notification, even when there are previous attributes stored in the attribute storage unit 101c, if the previous attributes were stored before the predetermined time from the current time, the voice determination unit 101i does not compare the current features and the previous features. Further, as a result of this notification, even when previous attributes were stored within a predetermined time from the current time, if none of the current attributes match any of the previous attributes, the voice determination unit 101i does not compare the current features and the previous features. The voice cutout unit 101e cuts out, from the audio data, the voice data from the start of speech to an interruption in the speech, and outputs the voice data thus cut out to the feature extraction unit 101f and the voice encoding unit 101h. The voice encoding unit 101f encodes the voice data to generate encoded voice data, and outputs the encoded voice data to the transmission unit 101j. The feature extraction unit 101g extracts features from the voice data, and stores in the feature storage unit 101h and outputs to the voice determination unit 101i the extracted features in association with the current time at which the features were extracted. The transmission unit 101j transmits the attributes and the encoded voice data to the server 200 via the communication I/F 106. The reception unit 201a of the server 200 receives the attributes and the encoded voice data via the communication I/F 206, outputs the encoded voice data to the voice decoding unit 201b, and outputs the attributes to the scenario determination unit 201d. The scenario determination unit 201d selects a scenario for one adult male such as shown in Table 2 based on the attributes of one adult male (Yes in S1202→S1203). If the current attributes are one child, the scenario determination unit 201d selects a scenario for one child different from the scenario for one adult male (No in S1202→S1204). The voice decoding unit 201b decodes the encoded voice data to generate voice data, and outputs the voice data to the text conversion unit 201c. The text conversion unit 201c converts the voice data into text data to generate text data, and outputs the generated text data to the scenario determination unit 201d. The scenario determination unit 201d selects, from the text data and the scenarios for one adult male selected based on the current attributes, text data of the voice (e.g., “Men's clothes are on the second floor, in the back” (refer to Table 1 or Table 2)) to be output to the person (adult male), and outputs the selected text data to the voice synthesizing unit 201e. The voice synthesizing unit 201e converts the text data into voice data to generate voice data, and outputs the generated voice data to the voice encoding unit 201f. The voice encoding unit 201f encodes the voice data to generate encoded voice data, and outputs the encoded voice data to the transmission unit 201g. The transmission unit 201g transmits the encoded voice data to the digital signage 100 via the communication I/F 206. The reception unit 101k of the digital signage 100 receives the encoded voice data via the communication I/F 106, and outputs the encoded voice data to the voice decoding unit 101l. The voice decoding unit 101l decodes the encoded voice data to generate voice data, and outputs the voice data to the voice output unit 101m. The voice output unit 101m outputs the voice data to the speaker 112, and the speaker 112 outputs the voice data for the person. As described above, the voice “Men's clothes are on the second floor, in the back” for the person (the adult male) is output from the digital signage 100.

In response, immediately, in S1205, the adult male speaks, saying, for example, “Thank you! I will go to the second floor” (refer to Table 2), and the microphone 111 collects and digitizes this speech and outputs the digitized speech to the voice input unit 101d. At this time, the camera 110 takes an image of a subject (child) that further appears in the space in front of the digital signage 100 and the adult male, digitizes the image taken, and outputs the digitized image to the image input unit 101a. The image input unit 101a outputs the image data to the attribute determination unit 101b, and the voice input unit 101d outputs the audio data to the voice cutout unit 101e.

In S1206, the following processing is executed. The attribute determination unit 101b analyzes the image, determines the gender(s) and age(s) along with the number of persons in the image, and stores in the attribute storage unit 101c and outputs to the transmission unit 101j the determined gender(s) and age(s) (that is, there is one adult male and one child) in association with the current time at which the attributes were determined and the image. Here, the condition that previous attributes stored in the attribute storage unit 101c within a predetermined time from the current time exist, and at least one of the current attributes of the one or more persons matches any one of the previous attributes are satisfied, and thus the attribute determination unit 101b notifies the voice determination unit 101i of the above-described determination result, which is positive. The voice cutout unit 101e cuts out, from the audio data, the voice data from the start of speech to an interruption in the speech, and outputs the voice data thus cut out to the feature extraction unit 101f and the voice encoding unit 101h. The voice encoding unit 101f encodes the voice data to generate encoded voice data, and outputs the encoded voice data to the transmission unit 101j. The feature extraction unit 101g extracts features from the voice data, and stores in the feature storage unit 101h and outputs to the voice determination unit 101i the extracted features in association with the current time at which the features were extracted. The voice determination unit 101i compares the current features and the previous features stored in the feature storage unit 101h and determines that the speaker (person) of the voice has not changed. The voice determination unit 101i outputs the determination result indicating that the speaker has not changed to the transmission unit 101j. The transmission unit 101j transmits the attributes, the encoded voice data, and the determination result to the server 200 via the communication I/F 106. The reception unit 201a of the server 200 receives the attributes, the encoded voice data, and the determination result via the communication I/F 206, outputs the encoded voice data to the voice decoding unit 201b, and outputs the attributes and the determination result to the scenario determination unit 201d. The scenario determination unit 201d determines, based on the attributes of there being one adult male and one child and the determination result indicating that the speaker has not changed, that the scenario for one adult male is to be continued (Yes in S1206→No in S1208→S1209). In S1205, if the child speaks, saying, for example, “Is there something there for me?” (refer to Table 1), the scenario determination unit 201d selects, based on the attributes of there being one adult male and one child, in addition to the determination result indicating that the speaker has changed, a scenario for a family and determines that the scenario is to transition from the scenario for one adult male to the scenario for a family (Yes in S1206→Yes in S1208→S1210). Further, in a case of No in S1206 (e.g., in a case where there is one adult female in the image or one adult male in the image), the scenario determination unit 201d determines that a scenario for one adult female different from the scenario for one adult male is to be selected (e.g., in the case of the former) or that the scenario for one adult male is to be continued (e.g., in the case of the latter). After these determinations are made, processing similar to that described above is executed.

In summary, in Example 1, in a first determination, it is determined from an image that one adult male is in front of the digital signage 100 and, in a second determination, it is determined from an image that one adult male and one child are in front of the digital signage 100 and, from a voice, that there is a change in voice. From these determination results, because both the adult male and the child took part in the conversation, the visit to the store is recognized as a family visit, and the scenario determination unit 201d selects a scenario for a family such as shown in Table 1, and provides guidance to the two persons of the adult male and the child. Instead of determining whether there is a change in voice from the voice, the speaker may be detected from the image, information indicating the speaker may be transmitted to the server 200 as described above and, in S1208, whether to continue the previous scenario or select another scenario may be determined based on comparison between the previously detected speaker and the currently detected speaker. Further, in a case where the attributes of the speaker (here, at least one of a gender and an age) determined by the voice determination unit 101i are transmitted from the digital signage 100 to the server 200, these attributes may additionally or alternatively be considered in S1208.

On the other hand, in Example 2, in a first determination, it is determined from an image that one adult male is in front of the digital signage 100 and, in a second determination, it is determined from an image that one adult male and one child are in front of the digital signage 100 and, from a voice, that there is no change in voice. From these determination results, because the child did not take part in the conversation, the child is not recognized as a family, and the scenario determination unit 201d continues the scenario for one adult male such as shown in Table 2, and provides guidance to the one adult male only.

TABLE 1
Example of Scenario for Family
S: Digital Signage, P1: Adult male, P2: Child
[Image of adult male recognized]

| | |
|---|---|
| S | Welcome! Are you looking for something? |
| P1 | I came to buy clothes. |

[Voice of adult male recognized]

| | |
|---|---|
| S | Men's clothes are on the second floor, in the back. |

[Image of adult male and child recognized]

| | |
|---|---|
| P2 | Is there something for me? |

[Voice of child recognized]

| | |
|---|---|
| S | On the second floor, children's clothes are in the |
| | front, and men's clothes are in the back. |
| | On the third floor, you will also find a game |
| | corner and a book corner. |
| | Enjoy your shopping! |

TABLE 2
Example of Scenario for One Adult Male
S: Digital Signage P1: Adult male
[Image of adult male recognized]

| | |
|---|---|
| S | Welcome! Are you looking for something? |
| P1 | I came to buy clothes. |

[Voice of adult male recognized]

| | |
|---|---|
| S | Men's clothes are on the second floor, in the back. |

[Image of adult male and child recognized]

| | |
|---|---|
| P1 | Thank you! I will go to the second floor. |

[Voice of adult male recognized]

| | |
|---|---|
| S | On the third floor, you will also find a book corner. |
| | Enjoy your shopping! |

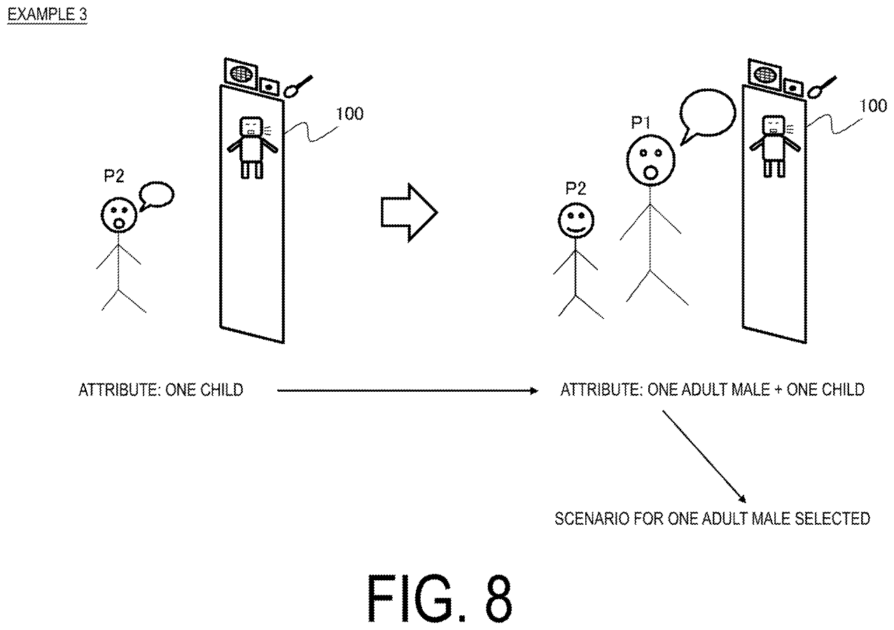

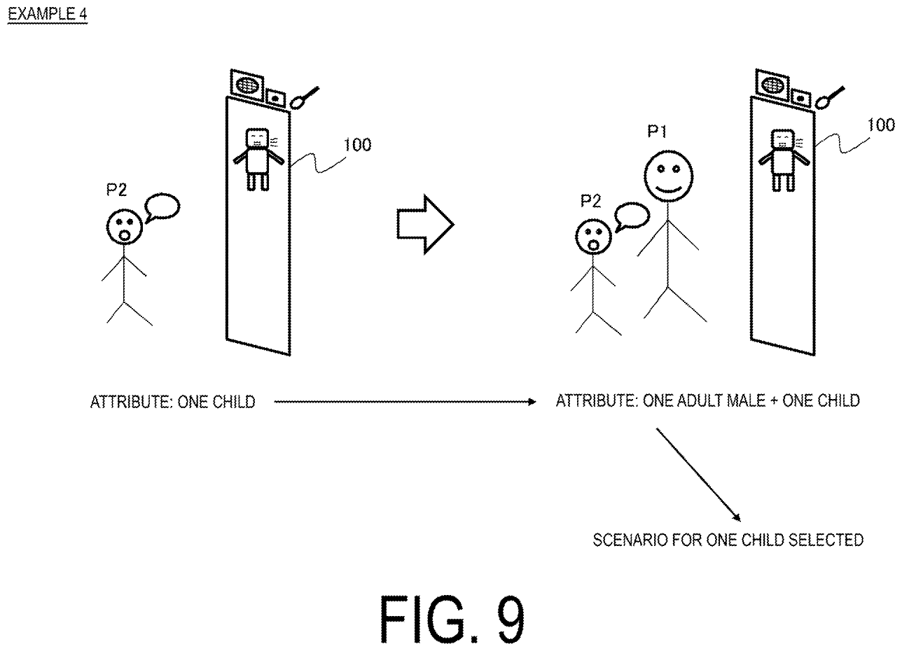

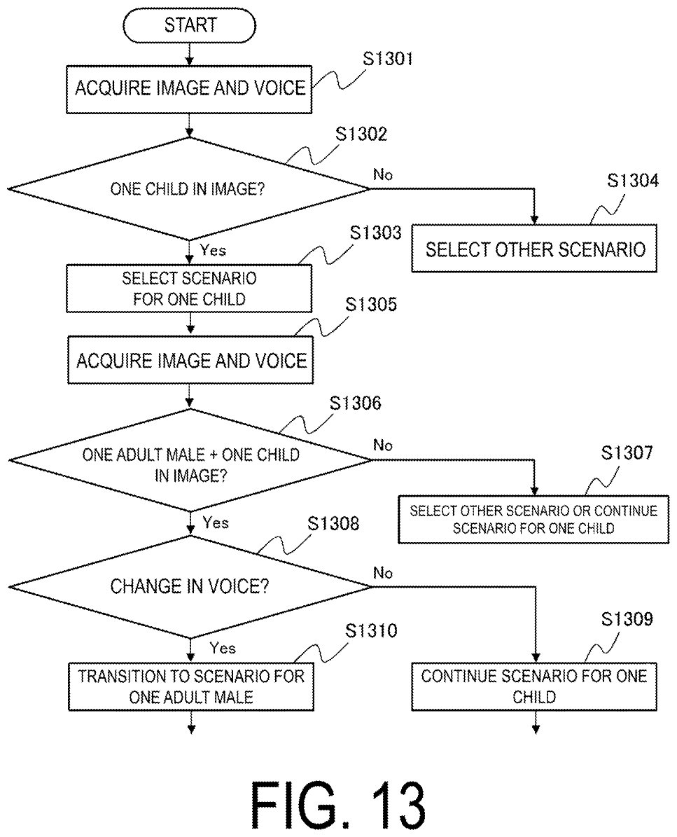

Example 3 illustrated in FIG. 8 assumes a case in which, at first, one child speaks to the digital signage 100, and subsequently one adult male further appears in front of the digital signage 100 and speaks to the digital signage 100. Example 4 illustrated in FIG. 9 assumes a case in which, at first, one child speaks to the digital signage 100, and subsequently one adult male further appears in front of the digital signage 100, and the child speaks to the digital signage 100. FIG. 13 is a flowchart illustrating an example of the information processing method for providing voice interaction in connection with Example 3 and Example 4 according to the embodiment, and Table 3 and Table 4 below show examples of a scenario for one adult male and a scenario for one child, respectively. The processing in FIG. 13 is similar to the processing in FIG. 12, and thus only a summary is described below.

In Example 3, in the first determination, it is determined from an image that one child is in front of the digital signage 100 and, in the second determination, it is determined from an image that one adult male and one child are in front of the digital signage 100 and, from a voice, that there is a change in voice. From these determination results, because the conversation with the child ended, the child is not recognized as a family, and the scenario determination unit 201d selects a scenario for one adult male such as shown in Table 3, and switches to providing guidance to the one adult male. Note that, in this example, while the conversation with the child ended and thus the child is not recognized as a family, both the adult male and the child took part in a conversation, and thus the visit may be recognized as a family visit and a scenario for a family may be selected.

On the other hand, in Example 4, in a first determination, it is determined from an image that one child is in front of the digital signage 100 and, in a second determination, it is determined from an image that one adult male and one child are in front of the digital signage 100 and, from a voice, that there is no change in voice. From these determination results, because the adult male did not take part in the conversation, the adult male is not recognized as a family, and the scenario determination unit 201d continues the scenario for one child such as shown in Table 4, and provides guidance to the one child only. Note that in a case where a scenario for one child is selected, the guidance for the child may be given by a voice that is child-oriented.

TABLE 3
Example of Scenario for One Adult Male
S: Digital Signage P1: Adult male
[Voice of child recognized]

| | |
|---|---|
| S | Welcome! Are you looking for something? |
| P2 | Hello! |

[Voice of child recognized]

| | |
|---|---|
| S | Are you looking for children's clothes, toys, or |
| | stationery goods? |

[Image of adult male and child recognized]

| | |
|---|---|
| P1 | I came to buy clothes. |

[Voice of adult male recognized]

| | |
|---|---|
| S | Men's clothes are on the second floor, in the back. |
| P1 | Thank you! I will go to the second floor. |

[Voice of adult male recognized]

| | |
|---|---|
| S | On the third floor, you will also find a book corner. |
| | Enjoy your shopping! |

TABLE 4
Example of Scenario for One Child
S: Digital Signage, P1: Adult male, P2: Child
[Voice of child recognized]

| | |
|---|---|
| S | Welcome! Are you looking for something? |
| P2 | Hello! |

[Voice of child recognized]

| | |
|---|---|
| S | Are you looking for children's clothes, toys, or stationery |
| | goods? |

[Image of adult male and child recognized]

| | |
|---|---|
| P2 | I came to buy clothes! |

[Voice of child recognized]

| | |
|---|---|
| S | Children's clothes are on the second floor, in the front. |
| P2 | Thanks! Off to the second floor! |

[Voice of child recognized]

| | |
|---|---|
| S | On the third floor, you will also find a game corner. |
| | Enjoy your shopping! |

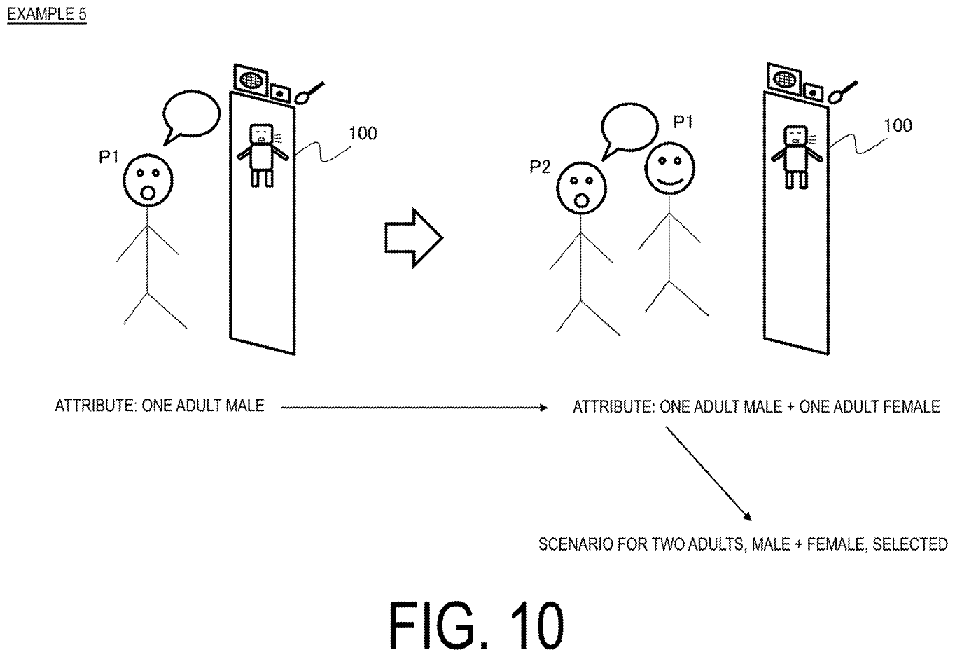

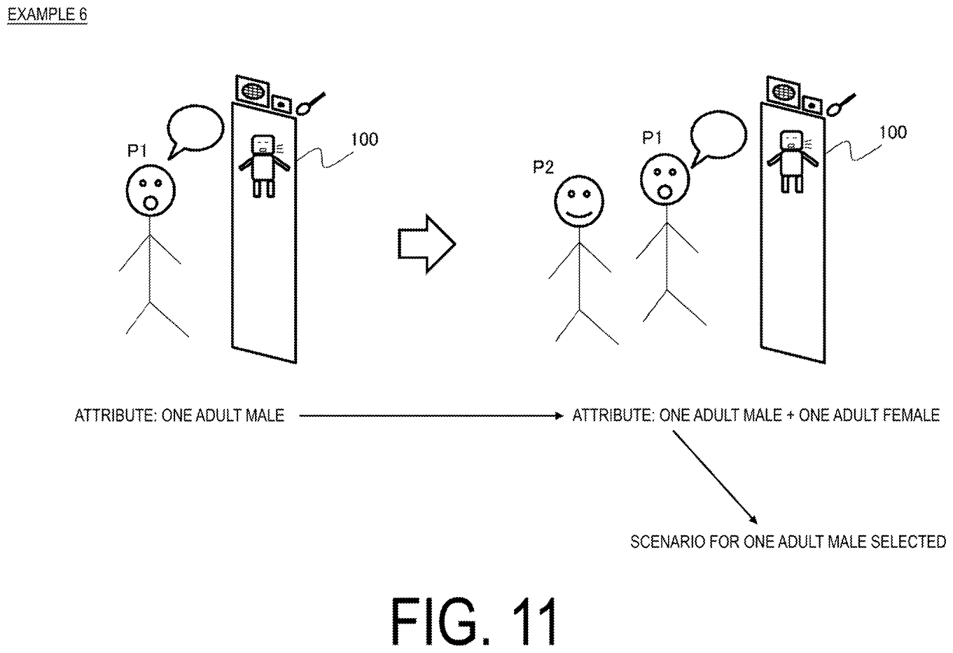

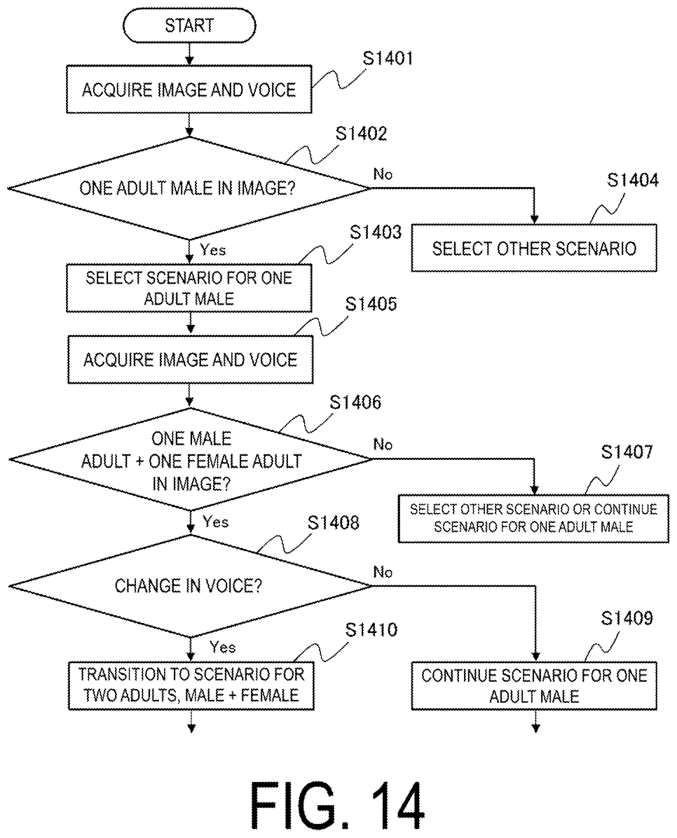

Example 5 illustrated in FIG. 10 assumes a case in which, at first, one adult male speaks to the digital signage 100, and subsequently one adult female further appears in front of the digital signage 100 and speaks to the digital signage 100. Example 6 illustrated in FIG. 11 assumes a case in which, at first, one adult male speaks to the digital signage 100, subsequently one adult female further appears in front of the digital signage 100, and the adult male speaks to the digital signage 100. FIG. 14 is a flowchart illustrating an example of the information processing method for providing voice interaction in connection with Example 5 and Example 6 according to the embodiment, and Table 5 and Table 6 below show examples of a scenario for two adults, male and female, and a scenario for one adult male, respectively. The processing in FIG. 14 is similar to the processing in FIG. 12, and thus only a summary is described below.

In Example 5, in a first determination, it is determined from an image that one adult male is in front of the digital signage 100 and, in a second determination, it is determined from an image that one adult male and one adult female are in front of the digital signage 100 and, from a voice, that there is a change in voice. From these determination results, because both the adult male and the adult female took part in the conversation, the visit to the store is recognized as a visit by an adult male and an adult female, and the scenario determination unit 201d selects a scenario for two adults, male and female, such as shown in Table 5, and provides guidance to the two persons of the adult male and the adult female.

On the other hand, in Example 6, in a first determination, it is determined from an image that one adult male is in front of the digital signage 100 and, in a second determination, it is determined from an image that one adult male and one adult female are in front of the digital signage 100 and, from a voice, that there is no change in voice. From these determination results, because the adult female did not take part in the conversation, the store visit is not recognized as a visit by an adult male and an adult female, and the scenario determination unit 201d continues the scenario for one adult male such as shown in Table 6, and provides guidance to the one adult male only.

TABLE 5
Example of Scenario for Two Adults, Male and Female
S: Digital Signage P1: Adult male P2: Adult female
[Image of adult male recognized]

| | |
|---|---|
| S | Welcome! Are you looking for something? |
| P1 | I came to buy clothes. |

[Voice of adult male recognized]

| | |
|---|---|
| S | Men's clothes are on the second floor, in the back. |

[Image of adult male and adult female recognized]

| | |
|---|---|
| P2 | Are women's clothes on the second floor as well? |

[Voice of adult female recognized]

| | |
|---|---|
| S | Women's clothes are on the third floor, in the front. |
| P2 | Thank you. |

[Voice of adult female recognized]

| | |
|---|---|
| S | On the third floor, you will also find a cafe corner. |
| | It is a nice place to relax after shopping! |

TABLE 6
Example of Scenario for One Adult Male
S: Digital Signage P1: Adult male
[Image of adult male recognized]

| | |
|---|---|
| S | Welcome! Are you looking for something? |
| P1 | I came to buy clothes. |

[Voice of adult male recognized]

| | |
|---|---|
| S | Men's clothes are on the second floor, in the back. |

[Image of adult male and adult female recognized]

| | |
|---|---|
| P1 | Thank you! I will go to the second floor. |

[Voice of adult male recognized]

| | |
|---|---|
| S | On the third floor, you will also find a book corner. |
| | Enjoy your shopping! |

An aspect of the present disclosure also relates to a program for causing the digital signage 100 or the server 200 to function as the functional units described above. The program, as described above, is stored in a storage device or a storage medium such as the RAM 103, the HDD 104, the RAM 203, or the HDD 204 of the digital signage 100 or the server 200, but may also be stored in another storage device or storage medium, or may be transmitted via a network. When the program is executed by the CPU 101 or the CPU 201 of the digital signage 100 or the server 200, the program may cause the digital signage 100 or the server 200, which is a computer, to function as the functional units described above. In other words, when the program is executed by the CPU 101 or the CPU 201 of the digital signage 100 or the server 200, the program may cause the digital signage 100 or the server 200, which is a computer, to execute steps of the information processing method according to an aspect of the present disclosure. Further, an aspect of the present disclosure also relates to a storage device or a storage medium configured to store the program described above.

As described above, according to an aspect of the present disclosure, it is possible to select a more suitable scenario and perform more appropriate interaction even in a case where a person taking part in an interaction changes midway through the interaction.

Further, in a configuration in which the functional units related to attribute determination are included in the digital signage 100, the image itself is not transmitted from the digital signage 100 to the server 200, and thus the effects of a delay caused by such transmission can be mitigated.

On the other hand, in a configuration in which the functional units related to attribute determination are included in the server 200 under condition that the image itself is transmitted to the server 200, the server 200 having a higher performance can process the attribute determination including image processing.

The embodiments disclosed in this application are illustrative and are not limited to the contents disclosed. The scope of the present disclosure is defined by the scope of the appended claims, and is intended to include all changes equivalent in meaning and scope to the claims.

What is claimed is:

1. An information processing device comprising:
a reception unit configured to receive an attribute of one or more persons from another device separate from the information processing device;
a determination unit configured to determine whether to continue a scenario for executing interaction or select another scenario, based on the attribute received by the reception unit;
a voice synthesizing unit configured to generate voice data for at least one person of the one or more persons, based on the determination by the determination unit; and
a transmission unit configured to transmit the voice data generated by the voice synthesizing unit to the other device.

2. The information processing device according to claim 1,
wherein the reception unit further receives, from the other device, a determination result indicating whether a speaker has changed among a plurality of persons, and
the determination unit determines whether to continue the scenario or select the other scenario, based on the determination result received by the reception unit in addition to the attribute received by the reception unit.

3. The information processing device according to claim 1,
wherein the reception unit further receives, from the other device, a determined attribute of a speaker, and
the determination unit determines whether to continue the scenario or select the other scenario, based on the determined attribute received by the reception unit in addition to the attribute received by the reception unit.

4. The information processing device according to claim 1,
wherein, in a case where the reception unit receives, from the other device, a plurality of attributes of a plurality of persons,
the reception unit further receives, from the other device, information indicating a speaker among the plurality of persons, and
the determination unit determines whether to continue the scenario or select the other scenario, based on the information received by the reception unit in addition to the attribute received by the reception unit.

5. The information processing device according to claim 1,
wherein the attribute of the one or more persons includes a gender and an age of each of the one or more persons.

6. An information processing device,
wherein the information processing device is configured to receive an image including one or more persons from another device separate from the information processing device,
the information processing device is configured to determine an attribute of the one or more persons, based on the image thus received,
the information processing device is configured to determine whether to continue a scenario for executing interaction or select another scenario, based on the attribute thus determined,
the information processing device is configured to generate voice data for at least one person of the one or more persons, based on the determination, and
the information processing device is configured to transmit the voice data thus generated to the other device.

7. An information processing method executed by an information processing device, the method comprising:
receiving an attribute of one or more persons from another device separate from the information processing device;
determining whether to continue a scenario for executing interaction or select another scenario, based on the attribute thus received;
generating voice data for at least one person of the one or more persons, based on the determination; and
transmitting the voice data thus generated to the other device.

8. An information processing system comprising:
a first information processing device; and
a second information processing device,
wherein the first information processing device is configured to determine, based on an image including one or more persons, an attribute of the one or more persons,
the first information processing device is configured to transmit the attribute thus determined to the second information processing device,
the second information processing device is configured to receive the attribute from the first information processing device,
the second information processing device is configured to determine whether to continue a scenario for executing interaction or select another scenario, based on the attribute thus received,
the second information processing device is configured to generate voice data for at least one person of the one or more persons, based on the determination,
the second information processing device is configured to transmit the voice data thus generated to the first information processing device,
the first information processing device is configured to receive the voice data from the second information processing device, and
the first information processing device is configured to output the voice data for the at least one person of the one or more persons.

9. An information processing device,
wherein the information processing device is configured to determine, based on an image including one or more persons, an attribute of the one or more persons,
the information processing device is configured to determine whether to continue a scenario for executing interaction or select another scenario, based on the attribute thus determined,
the information processing device is configured to generate voice data for at least one person of the one or more persons, based on of the determination, and
the information processing device is configured to output the voice data for the at least one person of the one or more persons.

10. An information processing device comprising:
a processing device;
a storage device configured to store a program; and
a communication device,
wherein the processing device is configured to execute the program stored in the storage device and, when executing the program,
receive an attribute of one or more persons from another device separate from the information processing device via the communication device,
determine whether to continue a scenario for executing interaction or select another scenario, based on the attribute thus received via the communication device,
generate voice data for at least one person of the one or more persons, based on the determination, and
transmit the voice data thus generated to the other device via the communication device.

11. An information processing device comprising:
a processing device; and
a storage device configured to store a program,
wherein the processing device is configured to execute the program stored in the storage device and, when executing the program,
determine, based on an image including one or more persons, an attribute of the one or more persons,
determine whether to continue a scenario for executing interaction or select another scenario, based on the attribute thus determined,
generate voice data for at least one person of the one or more persons, based on the determination, and
output the voice data for the at least one person of the one or more persons.
